(19) United States
(12) Patent Application Publication
(10) Pub. No.: US 2022/0311167 A1
(43) Pub. Date: Sep. 29, 2022

(54) PHOTODETECTOR

(71) Applicants: Go SHIMIZU, Tokyo (JP); Keisuke MAEDA, Tokyo (JP); Takashi MAI, Tochigi (JP); Kotaro ONO, Aichi (JP); Takayuki SUZUKI, Aichi (JP); Satoshi CHIKAZAWA, Aichi (JP)

(72) Inventors: Go SHIMIZU, Tokyo (JP); Keisuke MAEDA, Tokyo (JP); Takashi MAI, Tochigi (JP); Kotaro ONO, Aichi (JP); Takayuki SUZUKI, Aichi (JP); Satoshi CHIKAZAWA, Aichi (JP)

(73) Assignees: HONDA MOTOR CO., LTD., Tokyo (JP); NIDEC MOBILITY CORPORATION, Aichi (JP)

(21) Appl. No.: 17/701,581

(22) Filed: Mar. 22, 2022

(30) Foreign Application Priority Data
Mar. 24, 2021 (JP) 2021-050549

(51) Int. Cl. H01R 13/502; H01R 13/73; G01J 1/02

(52) U.S. Cl. CPC H01R 13/502; H01R 13/73; G01J 1/0271; H01R 2201/26

(57) ABSTRACT

A photodetector includes: an upper case including a light receiving portion on an upper surface and a side portion extending downward from the light receiving portion; a printed circuit board facing the light receiving portion; and a lower case including a support portion configured to support the printed circuit board, an opening on one side surface and configured to allow a connector to be inserted therethrough, and a hook on another side surface. The lower case is fitted to the upper case such that at least the printed circuit board and the support portion are surrounded. The upper case has a cut portion configured to prevent interference with the hook when being attached. At least part of the side portion adjacent to the cut portion and on a side of the opening extends up to a lower side of the opening.

### CROSS-REFERENCE TO RELATED APPLICATIONS

This application is based upon and claims the benefit of priority from Japanese Patent Application No. 2021-50549 filed on Mar. 24, 2021, the entire contents of which are incorporated herein by reference.

### FIELD

One or more embodiments of the present invention relate to a photodetector to be provided in a vehicle.

### BACKGROUND

In the related art, a photodetector provided in a vehicle for automatically controlling headlights, an air conditioner, and the like of the vehicle has been known. For example, as disclosed in JP-A-2011-226946 and JP-A-2015-004666, the photodetector detects the illuminance of light incident on the vehicle, the amount of solar radiation, infrared rays, and the like by a light receiving element to control the headlights, the air conditioner, and the like based on a detection result.

For example, JP-A-2011-226946 discloses a photodetector capable of facilitating assembly while realizing miniaturization. The photodetector includes an illuminance sensor and a solar radiation sensor, a microcomputer that controls the headlights and tail lights based on a detection result of the illuminance sensor, a printed wiring board on which the illuminance sensor and the microcomputer are mounted, a holding member that holds the printed wiring board, and a housing that stores the holding member. Further, a connector portion having an opening portion at a lower end is provided, and an external connector is configured to be attachable from a lower side.

Further, JP-A-2015-004666 discloses a photodetector capable of detecting ambient light incident at a predetermined tilt angle from all directions while realizing miniaturization. The photodetector guides light that has passed through a lens on an upper side by a light guide member and detects the light by a photodetection element on a lower side.

Further, a connector portion having an opening portion at a lower end is provided, and a connector provided at one end of a harness is fitted.

On the other hand, the photodetector is often installed on an upper surface of a dashboard. In consideration of the photodetector installed in an open car with an open roof or a vehicle with a sunroof, it is necessary to prevent water from entering the printed circuit board accommodated inside or a connection terminal with the connector, so that it is required to adopt a structure in which it is difficult for water to enter. For example, in a switch or the like that accommodates electronic components inside and is installed in a door that is easily exposed to rain, or the like, as disclosed in WO-A1-2011/118268 and JP-A-H09-204842, it has been devised to prevent entry of water.

WO-A1-2011/118268 discloses a switch unit including an upper case to which an operation unit is attached, a circuit board to which a switch capable of switching contact points by operating the operation unit is attached, and a lower case which fits into the upper case such that side surfaces are surrounded by the upper case and which accommodates a circuit board with the upper case. The switch unit includes, on a side surface of the upper case, a draining portion which is formed integrally with a side wall forming the side surface to project downward, and gradually narrows in width from the upper side to the lower side. The flow of water is concentrated on the draining portion to prevent water from entering the circuit board.

Further, JP-A-H09-204842 discloses a connector-attached switch box including a switch knob on an upper surface of the box, contact points inside, and a connector on a side portion, respectively. In the switch box, an eave portion covering an upper side of the connector and a side water stop wall covering both sides of the connector are attached to the box, and an upper part water stop wall is installed on a front edge of the eave portion, thereby preventing water from flowing into a side of the connector by guiding water to the side water stop wall after receiving water from the upper side by the eave portion.

### SUMMARY

In the above-described photodetector, the connector portion for connecting to the external connector attached to a tip of the harness is configured to receive the external connector from a lower end of the photodetector. However, depending on an attachment space in the vehicle, it may be required to receive the external connector from a side rather than from below. In this case, even though a liquid is splashed on an upper side of the photodetector, it is necessary to prevent the liquid from traveling along a side surface and wrapping around and entering the connector portion.

One or more embodiments of the present invention have been made in view of such circumstances, and an object thereof is to provide a photodetector realizing miniaturization and also having good drainage property by preventing a liquid from wrapping around and entering a connector.

In one or more embodiments of the present invention, there is provided a photodetector including: an upper case including a light receiving portion on an upper surface and a side portion extending downward from the light receiving portion; a printed circuit board that faces the light receiving portion, the printed circuit board being provided with an electronic component mounted thereon; and a lower case including a support portion configured to support the printed circuit board, an opening on one side surface and configured to allow a connector to be inserted therethrough, and a hook on another side surface and configured to be attached to an outside of the lower case, wherein the lower case is fitted to the upper case such that at least the printed circuit board and the support portion are surrounded, wherein the upper case has a cut portion configured to prevent interference with the hook when being attached, and wherein at least part of the side portion adjacent to the cut portion and on a side of the opening extends up to a lower side of the opening.

With this configuration, the lower case is fitted to the upper case such that the support portion and the printed circuit board are surrounded, and part of the side portion adjacent to the cut portion of the upper case extends up to the lower side of the opening. Consequently, it is possible to provide the photodetector realizing miniaturization and also having good drainage property by preventing a liquid from wrapping around and entering the connector.

Further, a gap configured to prevent a liquid from climbing up may be formed between an extending portion of the side portion and a side surface of the lower case, the extending portion extending up to the lower side of the opening.

With this configuration, by providing the gap between the extending portion and the side surface of the lower case, it is possible to prevent the liquid flowing down to the extending portion from climbing up, so that it is possible to further improve the drainage property in order to prevent the liquid from wrapping around and entering the connector.

Further, the cut portion of the upper case may have a shape corresponding to the hook of the lower case.

With this configuration, since the cut portion formed in the upper case has the shape corresponding to the hook, it is possible to efficiently reduce an overall size without interfere when being attached.

Further, the upper case may include an overhanging portion on a side surface corresponding to the one side surface of the lower case.

With this configuration, by providing the overhanging portion on an upper side of the side surface corresponding to one side surface of the lower case, that is, the side surface to which the external connector is connected, it is possible to prevent the liquid from wrapping around and entering the connector.

As described above, according to one or more embodiments of the present invention, it is possible to provide a photodetector realizing miniaturization and also having good drainage property by preventing a liquid from wrapping around and entering a connector.

### BRIEF DESCRIPTION OF DRAWINGS

FIG. 1A is a front view, FIG. 1B is a plan view, FIG. 1C is a left side view, FIG. 1D is a right side view, FIG. 1E is a rear side view, FIG. 1F is a bottom view, and FIG. 1G is a perspective view of a photodetector according to a first embodiment of the present invention.

FIG. 2A is a front view, FIG. 2B is a plan view, FIG. 2C is a left side view, FIG. 2D is a right side view, FIG. 2E is a rear side view, FIG. 2F is a bottom view, and FIG. 2G is a perspective view of an upper case of the photodetector according to the first embodiment of the present invention.

FIG. 3A is a front view, FIG. 3B is a plan view, FIG. 3C is a left side view, FIG. 3D is a right side view, FIG. 3E is a rear side view, FIG. 3F is a bottom view, and FIG. 3G is a perspective view (including a printed circuit board) of a lower case of the photodetector according to the first embodiment of the present invention.

FIG. 4A is a cross-sectional view taken along a line A-A, FIG. 4B is a cross-sectional view taken along a line B-B, FIG. 4C is a cross-sectional view taken along a line C-C, and FIG. 4D is a cross-sectional view taken along a line D-D of the photodetector according to the first embodiment of the present invention. Each cross section is shown in FIGS. 1B and 1C.

FIG. 5 is a perspective view of the photodetector according to the first embodiment of the present invention.

FIG. 6A is a plan view in which the printed circuit board provided inside is illustrated and FIG. 6B is a perspective view excluding the upper case of the photodetector according to the first embodiment of the present invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, an embodiment of the present invention will be described with reference to the accompanying drawings.

First Embodiment

A photodetector 100 according to the embodiment is a so-called auto light sensor for automatically controlling the turning on and off of headlights and tail lamps (not shown) of a vehicle (mainly an automatic four-wheeled vehicle). Typically, when a driver sets a switch for performing an operation of turning on and off the headlights and the like to an auto position, the headlights and the like are turned on and off according to illuminance detected by the photodetector 100.

The photodetector 100 includes an illuminance sensor that detects illuminance of light incident on a periphery of the vehicle or inside the vehicle, a microcomputer (microcontroller, not shown) that determines whether to turn on or off light based on a detection result detected by the illuminance sensor, and a communication circuit (not shown) that delivers a determination result of the microcomputer as a control signal to a vehicle control unit (not shown) via, for example, a Controller Area Network (CAN). The illuminance sensor includes, for example, a photodiode, a transistor, and the like which are integrated with other, converts light incident on a light receiving element into a current, and detects light when a voltage corresponding to brightness appears at both ends of a resistor installed in a circuit. There are other methods for detecting light, and the present invention is not limited thereto.

When illuminance detected by the illuminance sensor is smaller than a predetermined threshold value, the microcomputer determines that the periphery of the vehicle is dark and outputs a command to turn on the headlights and the like. Further, when the illuminance detected by the illuminance sensor is larger than the predetermined threshold value, the microcomputer determines that the periphery of the vehicle is bright and outputs a command to turn off the headlights and the like. That is, the illuminance sensor and the microcomputer constitute an auto light control device that automatically controls turning on and off states of the headlights the like. Further, the photodetector 100 may be used to control an air conditioner or the like of the vehicle by including an infrared sensor inside and detecting a temperature in the vehicle.

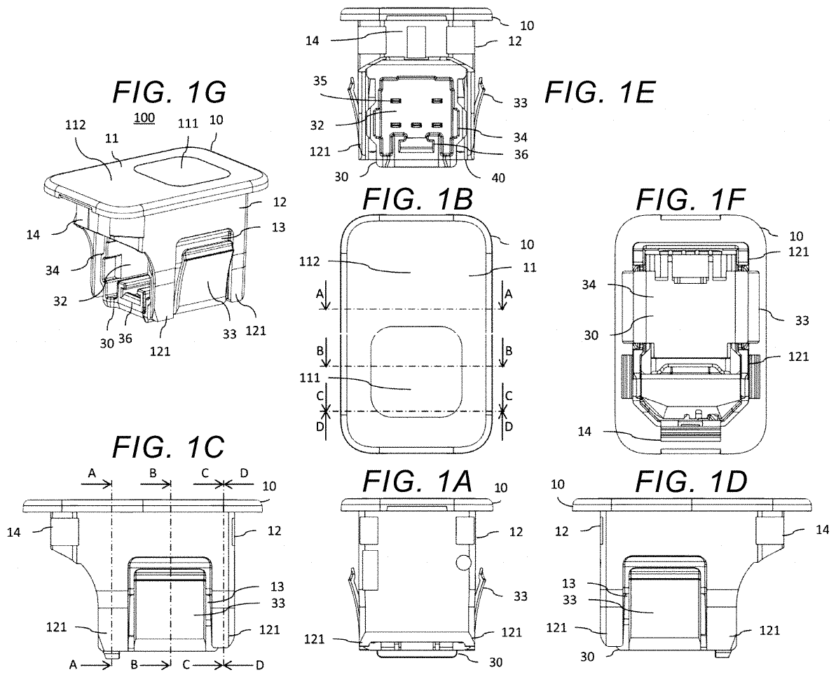

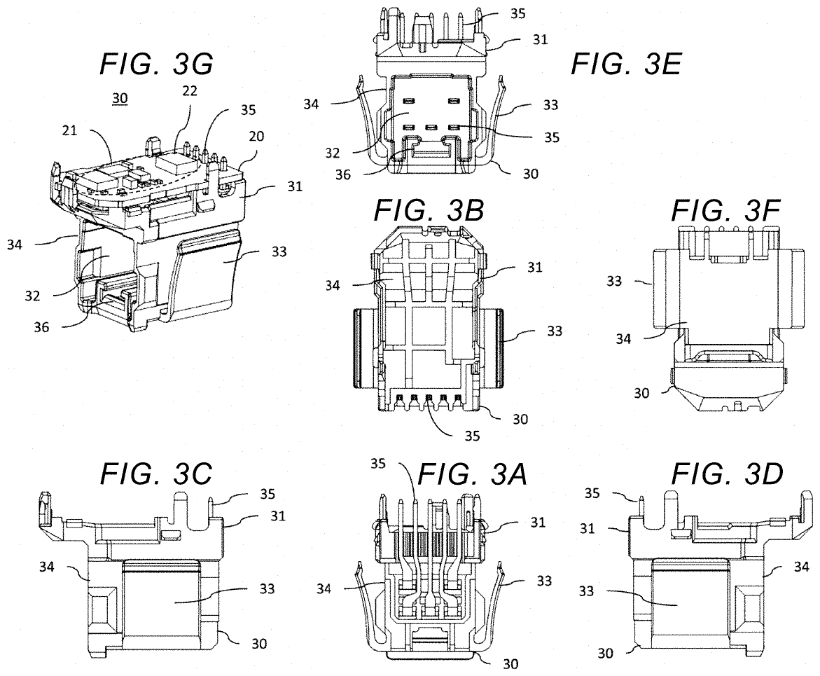

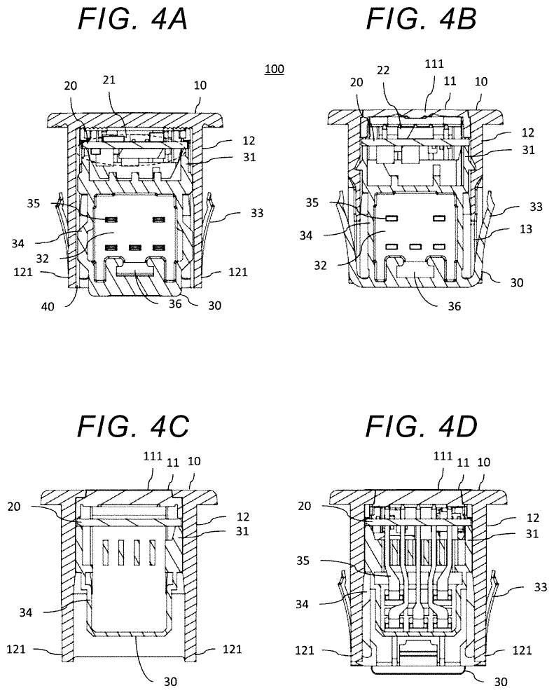

A structure of the photodetector 100 in the embodiment will be described in detail with reference to FIGS. 1A to 6B. The photodetector 100 includes an upper case 10 having a light receiving surface on an upper surface, a lower case 30 combined with the upper case 10, and a printed circuit board 20 accommodated between the upper case 10 and the lower case 30.

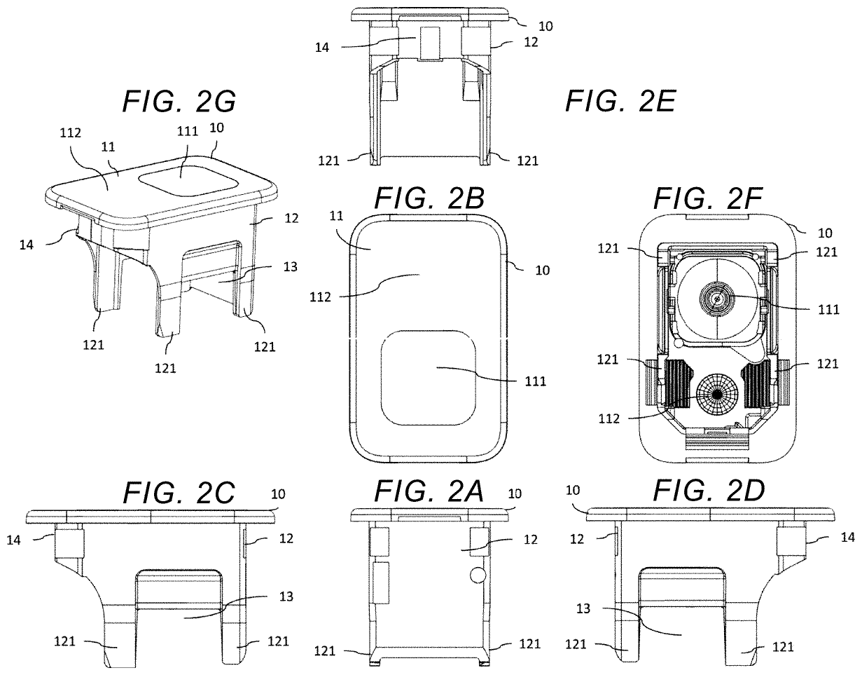

The upper case 10 includes a light receiving portion 11 having an upper surface serving as the light receiving surface for light incident on the vehicle, and a side portion 12 extending downward from a lower surface of the light receiving portion 11 to form a side surface of the upper case 10. The light receiving surface of the light receiving portion 11 is composed of the light receiving surface having a visible light transmission portion 111 (first region) that transmits visible light and an infrared light transmission portion 112 (second region) that transmits infrared light while transmitting a smaller amount of visible light than the visible light transmission portion 111. A lens is formed on a back surface of the visible light transmission portion 111 and the infrared light transmission portion 112 (see FIG. 2F), and light rays are concentrated on respective facing light receiving elements by the lens. The visible light transmission portion 111 is preferably made of polycarbonate that transmits visible light well. In the embodiment, a small amount of black pigment in polycarbonate, which is difficult to transmit infrared light, is mixed with the visible light transmission portion 111 and is fitted into the infrared light transmission portion 112 integrally molded with the side portion 12. A large amount of pigment is mixed with the infrared light transmission portion 112 such that visible light is difficult to be transmitted. The infrared light transmission portion 112 may not transmit visible light at all.

The side portion 12 is formed so as to cover at least the printed circuit board 20 and a periphery of a support portion 31 of the lower case 30 on all surfaces, and extends to a vicinity of a lower end of the lower case 30 in order to sufficiently cover a connection terminal 35 attached to the lower case 30 on a front surface side. On the other hand, since the side portion 12 fits an opening 32 of the lower case 30 for receiving an external connector on a back surface side, a part extending downward from the lower surface of the light receiving portion 11 is short and the side portion 12 approximately covers only the printed circuit board 20 and the periphery of the support portion 31 of the lower case 30.

The side portion 12 has a U-shaped cut portion 13 in a substantially central part on a left side surface and a right side surface, that is, on surfaces other than a part (front surface side) extending to the vicinity of the lower end of the lower case 30 to sufficiently cover the connection terminal 35 and a part fitting the opening 32 and extending downward shortly. The side portion 12 has side extending portions 121 extending to the vicinity of the lower end of the lower case 30 and extending up to a lower side of the opening 32 on both sides of the cut portion 13. When being attached to the vehicle, the cut portion 13 is provided to not interfere with a hook 33 even when the hook 33 of the lower case 30 is bent inward. As a result, miniaturization of an overall shape of the photodetector 100 can be realized. Further, the cut portion 13 preferably has a shape corresponding to the hook 33 of the lower case 30. As a result, it is possible to efficiently reduce an overall size without interference when being attached.

Further, the side extending portion 121 existing on a side of the cut portion 13, particularly, the side extending portion 121 on a side of the opening 32 extends up to the vicinity of the lower end of the lower case 30 which is the lower side of the opening 32. As a result, even in a case where a liquid such as water flows along the side portion 12, it is possible to prevent the liquid from wrapping around the lower case 30.

The lower case 30 has a connector accommodating body 34 formed in a substantially rectangular parallelepiped for receiving the external connector, a support portion 31 formed at an upper part of the connector accommodating body 34 to support the printed circuit board 20, an opening 32 for inserting the external connector into a back surface side (one side surface) of the lower case 30, the connection terminal 35 on a surface (front surface side) facing the opening 32, a connector guide portion 36 for guiding the external connector provided at a bottom of the connector accommodating body 34 to the connection terminal 35, and the hook 33 for attaching the photodetector 100 (or the lower case 30) to the vehicle on the left side surface and the right side surface (other side surface).

The support portion 31 is formed to have substantially the same shape as the printed circuit board 20 in an outer shape in a plan view, and preferably floats the printed circuit board 20 and supports the printed circuit board 20 on the periphery thereof in consideration of the electronic components which are mounted on a back side of the printed circuit board 20. The opening 32 substantially matches a shape of the external connector in an insertion direction. The external connector is inserted from the opening 32 and guided to the connector guide portion 36 to be press-fitted into one end of the connection terminal 35. Since the other end of the connection terminal 35 is connected to the printed circuit board 20, the external connector is electrically connected to the printed circuit board 20 by being press-fitted, and delivers an electric signal from the printed circuit board 20 to the vehicle control unit.

On the left side surface and the right side surface, the hook 33 stands up from a lower part of the connector accommodating body 34 and is formed to spread to both sides toward the upper side. The hook 33 has elasticity. For example, when being attached to an attachment hole provided in a dashboard of the vehicle, the photodetector 100 is pushed into the attachment hole and gradually bent inward, and a tip of the hook 33 passes through an edge of the attachment hole and returns to its original shape, so that the photodetector 100 is attached to the vehicle. The lower case 30, particularly, the hook 33 is preferably made of elastic polybutylene terephthalate.

The printed circuit board 20 faces the back side of the light receiving surface of the light receiving portion 11, and is mounted with a plurality of electronic components 21 including the illuminance sensor 22 (first light receiving element) that detects visible light, the infrared sensor 23 (second light receiving element) that detects infrared light, and other electronic components (for example, the microcomputer, the resistor, the capacitor, and the like). Of course, electronic components other than the above-described electronic components may be disposed on the back side of the printed circuit board 20. The illuminance sensor 22 provided on a light receiving surface side of the printed circuit board 20 is disposed directly below the visible light transmission portion 111 of the upper case 10, and other electronic components including the infrared sensor 23 are disposed directly below the infrared light transmission portion 112 of the upper case 10. By demonstrating a function of each of the sensors and disposing the other electronic components directly below the infrared light transmission portion 112 that does not transmit visible light compared to the visible light transmission portion 111, it is possible to minimize the electronic components that can be seen through the visible light transmission portion 111, thereby improving appearance design as a result.

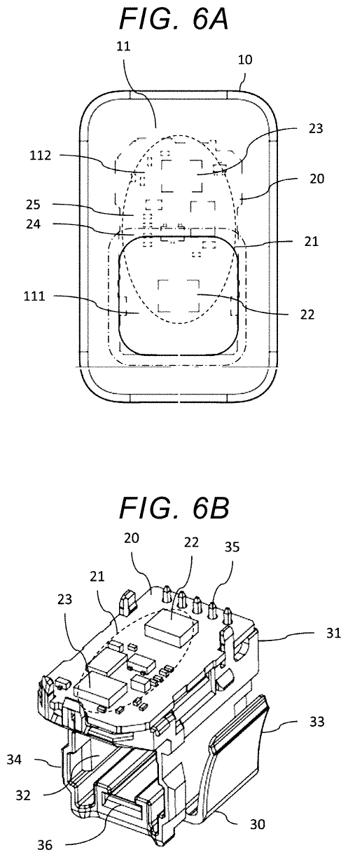

The visible light transmitted through the visible light transmission portion 111 is incident on inside the photodetector 100, and a region (first position 24), which is directly exposed to the printed circuit board 20, is slightly larger than the visible light transmission portion 111 in a plan view (see the first position 24 shown by the one-dot chain line in FIG. 6A) in consideration of a distance from the light receiving surface to the printed circuit board 20 and the visible light incident on the light receiving surface diagonally instead of vertically.

Since the first position 24 is a region directly exposed to visible light on the printed circuit board 20, in other words, the first position 24 is a region which is seen by the human eye through the visible light transmission portion 111.

Therefore, the illuminance sensor 22 is disposed at the first position 24, and the number of mounting points of the electronic components disposed at the first position 24 is preferably smaller than the number of mounting points of the electronic components disposed at the second position 25 other than the first position 24 on the printed circuit board 20. The second position 25 is a region outside the one-dot chain line of the first position 24 shown in FIG. 6A, in other words, a region which is not seen by the human eye through the visible light transmission portion 111. In this way, by reducing the number of mounting points of the electronic components disposed at the position exposed to the visible light to be smaller than the number of mounting points of the electronic components disposed at the other positions, it is possible to provide the photodetector 100 that improves the appearance design.

Further, by disposing the infrared sensor 23 at the second position 25, that is, not disposing the infrared sensor 23 for detecting invisible light at the position exposed to visible light, it is possible to provide the photodetector 100 which does not deteriorate the appearance design even with multiple functions.

In the photodetector 100, the lower case 30 is configured to be fitted to the side portion 12 of the upper case 10 such that the side portion 12 of the upper case 10 surrounds the printed circuit board 20 and the support portion 31 of the lower case 30, which supports the printed circuit board 20. Further, as described above, part of the side portion 12 adjacent to the side of the cut portion 13 of the upper case 10, serving as the side extending portion 121, extends up to the lower side of the opening 32. As a result, it is possible to provide the photodetector 100 realizing miniaturization and also having good drainage property by preventing the liquid from wrapping around and entering the external connector.

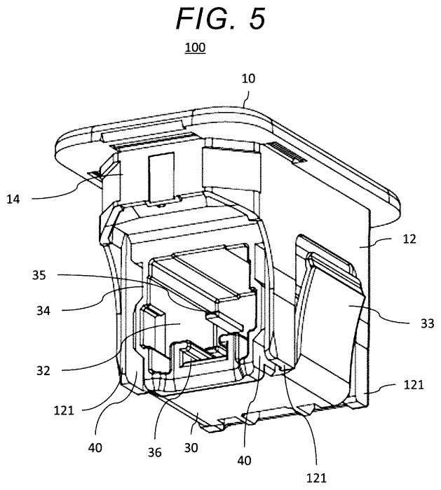

Further, as shown in FIG. 5, the photodetector 100 preferably includes a gap 40 for preventing the liquid from climbing up, between an outer side surface of the connector accommodating body 34 of the lower case 30 and an inner side surface of the side extending portion 121. When there is no gap 40, the liquid that has flown down to the lower end of the side extending portion 121 due to the capillary phenomenon between the connector accommodating body 34 and the side extending portion 121 may crawl up and wrap around and entering the external connector. In this way, since the gap 40 exists, it possible to prevent the liquid that has flown down to the side extending portion 121 from climbing up, so that it is possible to improve the drainage property in order to prevent the liquid from wrapping around and entering the external connector.

Further, the side portion 12 of the upper case 10 on the back surface side preferably includes an overhanging portion 14 formed to project in a side view to correspond to a side surface (one side surface) on the back surface side of the lower case 30 having the opening 32 through which the external connector is inserted. In this way, by providing the overhanging portion 14 on the upper side of the side surface corresponding to one side surface of the lower case 30, that is, the side surface to which the external connector is connected, it is possible to prevent the liquid from wrapping around and entering the external connector even though the liquid that has flowed along the side portion 12 on the back surface side drips from the lower end.

It should be noted that the present invention is not limited to the illustrated embodiment, and can be implemented with a configuration in a scope that does not departs from the content described in each section of the claims. That is, the present invention is mainly and particularly illustrated and described with respect to a specific embodiment, and those skilled in the art can make various modifications in the quantity and other detailed configurations with respect to the above-described embodiment without departing from a scope of the technical idea and an object of the present invention.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A photodetector comprising:
an upper case comprising a light receiving portion on an upper surface and a side portion extending downward from the light receiving portion;
a printed circuit board that faces the light receiving portion, the printed circuit board being provided with an electronic component mounted thereon; and
a lower case comprising a support portion configured to support the printed circuit board, an opening on one side surface and configured to allow a connector to be inserted therethrough, and a hook on another side surface and configured to be attached to an outside of the lower case,
wherein the lower case is fitted to the upper case such that at least the printed circuit board and the support portion are surrounded,
wherein the upper case has a cut portion configured to prevent interference with the hook when being attached, and
wherein at least part of the side portion adjacent to the cut portion and on a side of the opening extends up to a lower side of the opening.

2. The photodetector according to claim 1,
wherein a gap configured to prevent a liquid from climbing up is formed between an extending portion of the side portion and a side surface of the lower case, the extending portion extending up to the lower side of the opening.

3. The photodetector according to claim 1,
wherein the cut portion of the upper case has a shape corresponding to the hook of the lower case.

4. The photodetector according to claim 1,
wherein the upper case comprises an overhanging portion on a side surface corresponding to the one side surface of the lower case.
